(19) United States
(12) Patent Application Publication
(10) Pub. No.: US 2026/0140836 A1
(43) Pub. Date: May 21, 2026

(54) AUGMENTED SWITCH CAPACITY, REDUNDANT CROSSBARS, AND FAILOVER MECHANISMS IN CROSSBAR SYSTEMS

(71) Applicant: MaxLinear, Inc., Carlsbad, CA (US)

(72) Inventor: Curtis Ling, Carlsbad, CA (US)

(73) Assignee: MaxLinear, Inc., Carlsbad, CA (US)

(21) Appl. No.: 19/397,694

(22) Filed: Nov. 21, 2025

Related U.S. Application Data
(60) Provisional application No. 63/723,530, filed on Nov. 21, 2024.

(51) Int. Cl. G06F 11/20

(52) U.S. Cl. CPC G06F 11/2028

(57) ABSTRACT

Technology for a device is disclosed. The device may include a plurality of digital signal processors (DSPs). The device may include a plurality of analog crossbars operable to be connected to the plurality of DSPs. The device may include a set of redundant analog crossbars operable to be connected to the plurality of DSPs. The set of redundant analog crossbars may be operable to provide one or more of additional input lanes or additional output lanes when failover occurs.

### RELATED APPLICATION

This application claims the benefit of U.S. Provisional Application No. 63/723,530, filed Nov. 21, 2024, the disclosure of which is incorporated herein by reference in its entirety.

The examples discussed in the present disclosure are related to augmented switch capacity, redundant crossbars, and failover mechanisms in crossbar systems.

### BACKGROUND

Unless otherwise indicated herein, the materials described herein are not prior art to the claims in the present application and are not admitted to be prior art by inclusion in this section.

Datacenters and AI clusters may use Ethernet switches that are packet switched. Using a packet switched Ethernet switch results in delivery that is not reliable, variable, and high latency. Fabric switches provide another possibility in datacenters and artificial intelligence (AI) clusters. Fabric switches, unlike Ethernet switches, are equivalent to circuit-switched networks, rather than packet-switched networks.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A device may include a plurality of digital signal processors (DSPs); a plurality of analog crossbars that may be connected to the plurality of DSPs; and a set of redundant analog crossbars operable that may be connected to the plurality of DSPs. The set of redundant analog crossbars may be operable to provide one or more of additional input lanes or additional output lanes when failover occurs.

A method may include one or more of: receiving, at a plurality of analog crossbars from a plurality of digital signal processors (DSPs), first in-band (IB) switch traffic; sending, from the plurality of analog crossbars to a plurality of DSPs, second IB switch traffic; and receiving, at a set of redundant analog crossbars from the plurality of DSPs, third IB switch traffic when failover occurs, or sending, from the set of redundant analog crossbars to the plurality of DSPs, fourth IB switch traffic when failover occurs.

A device may include a plurality of digital signal processors (DSPs); a plurality of analog crossbars that may connect to the plurality of DSPs; and a set of redundant DSPs that may connect to the plurality of analog crossbars. The set of redundant DSPs may provide one or more of additional input lanes or additional output lanes when failover occurs.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example device including a plurality of digital signal processors (DSPs) and a plurality of analog crossbars with redundancy.

FIG. 2 illustrates an example device including a plurality of digital signal processors (DSPs) and a plurality of analog crossbars with redundancy.

FIG. 3 illustrates an example device including a plurality of digital signal processors (DSPs) and a plurality of analog crossbars with redundancy.

FIG. 4 illustrates an example device including a plurality of digital signal processors (DSPs) and a plurality of analog crossbars with redundancy.

FIG. 5 illustrates an example process flow of make-before-break (MBB) handoff.

FIG. 6A illustrates an example analog switch.

FIG. 6B illustrates an example analog switch.

FIG. 6C illustrates an example analog switch with redundancy.

FIG. 7 illustrates an example network topology with redundancy.

FIG. 8 illustrates an example process flow of a device for redundancy.

FIG. 9 illustrates an example communication system operable for redundancy.

FIG. 10 illustrates a diagrammatic representation of a machine in the example form of a computing device within which a set of instructions, for causing the machine to perform any one or more of the methods discussed herein, may be executed.

FIG. 11A illustrates an example block diagram of a data center.

FIG. 11B illustrates an example switch device.

FIG. 11C illustrates an example switch device.

FIG. 11D illustrates an example switch device.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single example, but other examples are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

Fabric switches may be used to reduce latency, reduce power, and increase throughput. When a connection in a fabric switch fails, there may be additional latency involved in switching over to a new connection. In addition, hitless switching reconfiguration may further increase the latency. Furthermore, when there is traffic congestion, then latency may increase and reconfiguration may be useful.

Redundancy may be used to reduce the latency involved in failover, hitless switching, and reconfiguration during congestion. For example, when a lane fails, a device may switch over to a redundant lane during failover. In addition, hitless switching may be simplified because two inputs may be allowed to disturb exactly two outputs. Also, during traffic congestion, additional paths may be used.

Redundancy may be implemented in a few different ways. Redundant crossbars may be used to provide additional input and output lanes. Additional lanes may be added to the components (e.g., digital signal processors, analog crossbars, redundant crossbars) involved in switching. In-band signaling may be supplemented by out-of-band signaling. In-band and out-of-band transceivers may provide additional means of communication between the components (e.g., digital signal processors, analog crossbars, redundant crossbars). Make-before-break may be used to reduce the latency when failover occurs.

Examples of the described herein will be explained with reference to the accompanying drawings.

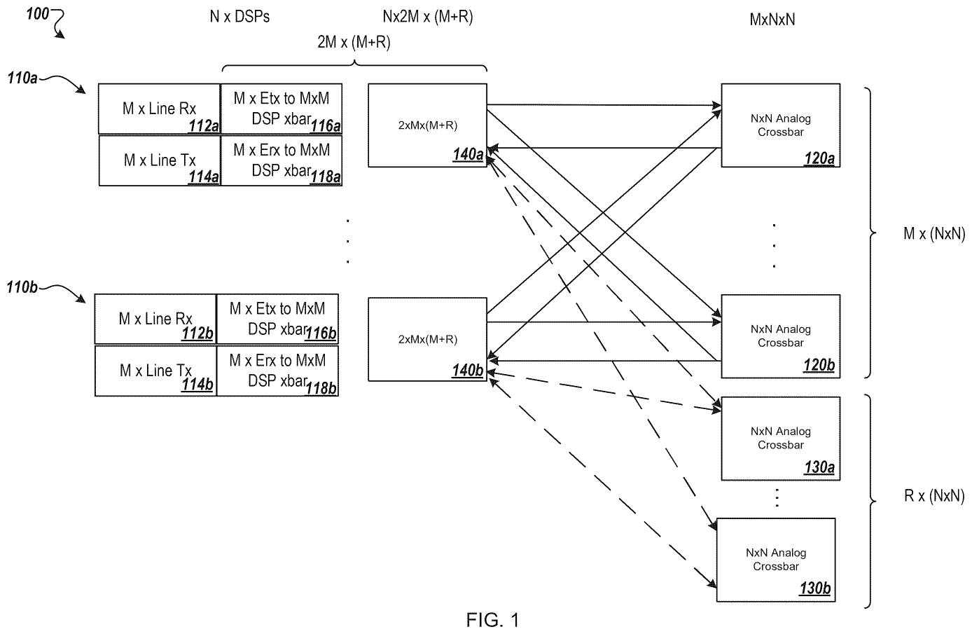

As illustrated in FIG. 1, a device 100 may include a plurality of PMDs. The plurality of PMDs may include a plurality of digital signal processors (DSPs) 110a, 110b. The device 100 may include a plurality of analog crossbars 120a, 120b that may be connected to the plurality of DSPs 110a, 110b. The device may include a set of redundant analog crossbars 130a, 130b that may connect to the plurality of DSPs 110a, 110b. The set of redundant analog crossbars 130a, 130b may provide one or more of additional input lanes or additional output lanes when failover occurs.

A plurality of physical media dependent (PMD) devices which may include DSPs 110a, 110b may have various functionality. On the line side, DSP 110a may receive line traffic using M×Line Rx 112a and transmit line traffic using M×Line Tx 114a. On the switch side, DSP 110a may transmit switch traffic using M×ETX to M×M DSP xbar 116a and may receive switch traffic using M×ERx to M×M DSP xbar 118a.

Similarly, on the line side, DSP 110b may receive line traffic using M×Line Rx 112b and may transmit line traffic using M×Line Tx 114b. On the switch side, DSP 110b may transmit switch traffic using M×ETx to M×M DSP xbar 116b and receive switch traffic using M×ERx to M×M DSP xbar 118b. Although two DSPs 110a and 110b are illustrated, there may be N DSPs in which N may be any integer greater than or equal to 1 (e.g., 2).

The PMDs may include a digital signal processor (DSP) 110a, 110b. The DSP 110a, 110b may have M×M DSP crossbar functionality in which ‘M’ refers to the number of lanes. The M×M DSP crossbar functionality may be modified to include a different number of lanes. In one example, the number of lanes for DSP 110a, 110b may be based on the crossbar dimensions M×(M+R) in which R refers to a number of redundant lanes. In another example, the number of lanes for DSP 110a, 110b may be based on the crossbar dimensions 2×M×(M+R) in which the Tx traffic uses crossbar dimensions having M×(M+R) and the Rx traffic uses crossbar dimensions having M×(M+R). The crossbar functionality for DSP 110a, 110b may be repeated in N iterations in which N refers to the number of DSPs 110a, 110b and/or PMDs.

The DSP 110a, 110b radix may be increased by increasing the number of analog crossbars (e.g., M to M+R). The DSP crossbar 140a, 140b may be coupled to M analog crossbars 120a, 120b and to R redundant analog crossbars 130a, 130b. For example, DSP crossbar 140a may be coupled to N×N analog crossbar 120a, N×N analog crossbar 120b, N×N redundant analog crossbar 130a, and N×N redundant analog crossbar 130b. Similarly, DSP crossbar 140b may be coupled to N×N analog crossbar 120a, N×N analog crossbar 120b, N×N redundant analog crossbar 130a, and N×N redundant analog crossbar 130b. There may be a total of M analog crossbars and a total of R redundant analog crossbars in which M is any integer (e.g., 2) greater than or equal to 1 and R is any integer (e.g., 2) greater than or equal to 1.

The in-band (IB) switch traffic from the DSP crossbars 140a, 140b may be directed to the N×N analog crossbars 120a, 120b. In addition, the IB switch traffic from the output of the M analog crossbars 120a, 120b may be directed to the DSP crossbars 140a, 140b.

The redundant analog crossbars 130a, 130b may be used for one or more of in-band traffic or out-of-band traffic. For example, the redundant paths between the DSP crossbars 140a, 140b and the redundant analog crossbars 130a, 130b may be used for IB traffic. For example, DSP crossbar 140a may direct IB traffic to redundant analog crossbars 130a, 130b, and redundant analog crossbars 130a, 130b may direct IB-traffic to DSP crossbars 140a. Similarly, DSP crossbar 140b may direct IB traffic to redundant analog crossbars 130a, 130b, and redundant analog crossbars 130a, 130b may direct IB traffic to DSP crossbars 140b.

The R alternative paths may be used to connect any input to any output. The R alternative paths may allow the resolution of up to R failures per analog crossbar integrated circuit (IC) (including input/output (I/O) buffer and switch failures). The R alternative paths may also provide for hitless switch reconfiguration by allowing two inputs to disturb exactly two outputs.

The device 100 may further include non-volatile memory that may store and recover a crossbar state after power loss. Storing a crossbar state may allow the state to be recovered faster after a power loss.

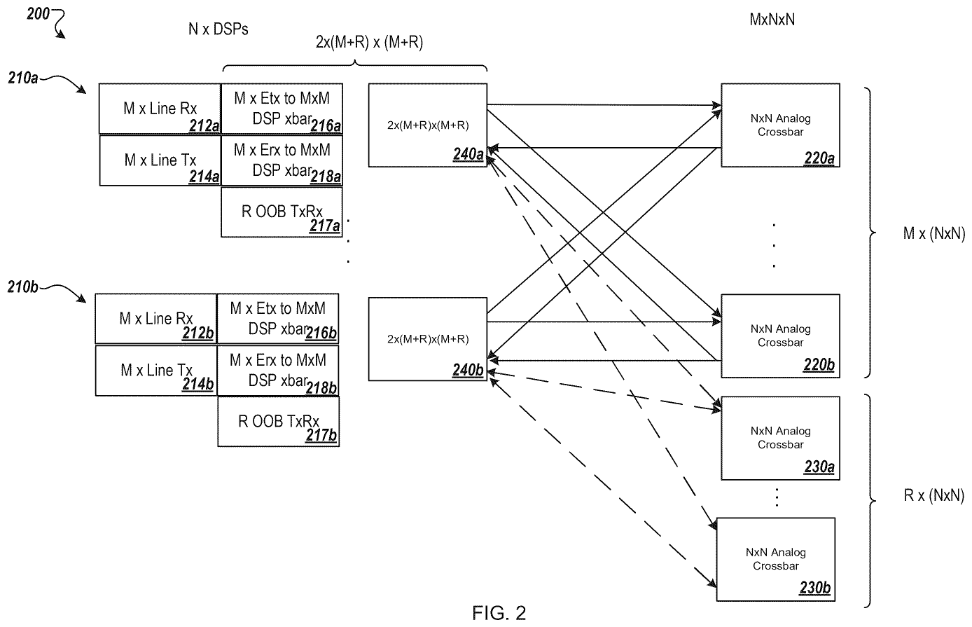

As illustrated in FIG. 2, in a device 200 provisions may be allowed for out-of-band (OOB) signaling. That is, the redundant analog crossbars 230a, 230b may provide redundancy for IB traffic, and provide for OOB traffic. For example, when R is equal to 2, one of the redundant analog crossbars 230a may be used for OOB traffic to DSP 210a, 210b and the other redundant analog crossbar 230b may be used for IB traffic to DSP 210a, 210b.

The DSP 210a, 210b may have R OOB transceivers (TxRx) 217a, 217b to connect to the R redundant analog crossbars 230a, 230b. For example, the OOB TxRx 217a, 217b may be 10G serial deserializer (SERDES), a serial peripheral interface, or the like. The DSPs 210a, 210b may also have the functionality previously discussed including M×Line Rx 212a, 212b, the M×Line Tx 214a, 214b, the M×ETx to M×M DSP xbar 216a, 216b, and the M×ERx to M×M DSP xbar 218a, 218b. The DSPs 210a, 210b may also have crossbar functionality 240a, 240b.

The redundant analog crossbars 230a, 230b may be used for various functions. For example, the redundant analog crossbars 230a, 230b may communicate to one or more DSPs 210a, 210b without blocking IB traffic.

A switch controller (SC) may broadcast OOB to the plurality of DSPs 210a, 210b and the analog crossbar ICs 220a, 220b and the redundant analog crossbars 230a, 230b. The SC may use OOB to communicate with individual DSPs 210a, 210b and/or analog crossbar ICs 220a, 220b and/or the redundant analog crossbars 230a, 230b. Time division multiplexing or broadcast may be used to address a subset of DSPs 210a, 210b and/or analog crossbar ICs 220a, 220b and/or redundant analog crossbars 230a, 230b. The SC may communicate control signals to the individual DSPs 210a, 210b and/or analog crossbar ICs 220a, 220b and/or the redundant analog crossbars 230a, 230b.

The analog crossbars 220a, 220b and the redundant analog crossbars 230a, 230b may include OOB Tx/Rx which may be used to be individually addressable. In some examples, time division multiplexing may be used to communicate to or from the analog crossbars 220a, 220b and redundant analog crossbars 230a, 230b.

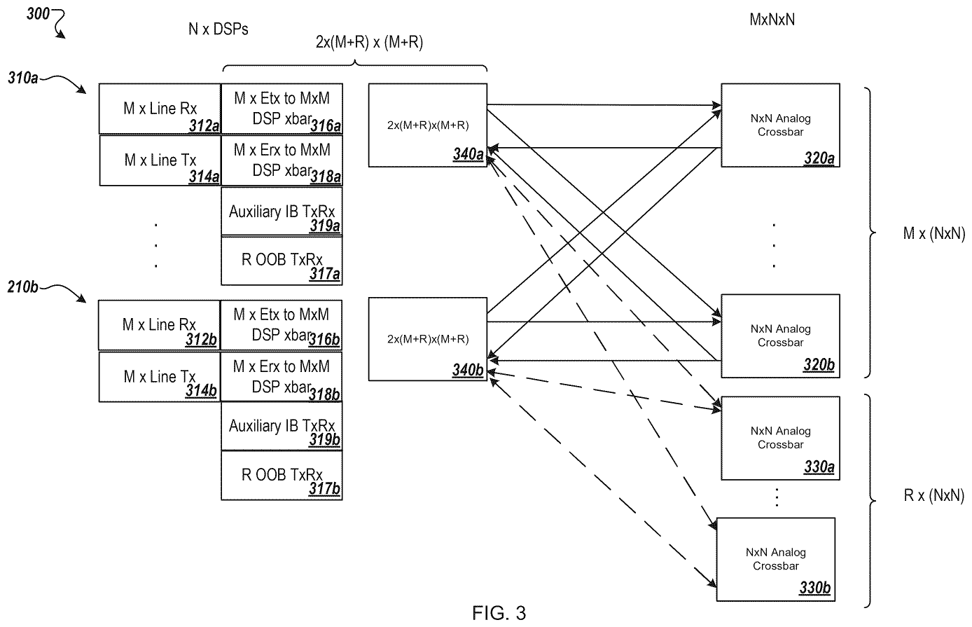

As illustrated in a device 300 in FIG. 3, one or more auxiliary in-band transceivers (aux IB Tx/Rx) 319a, 319b may be included in the DSPs 310a, 310b. The aux IB channel may be the same as the other IB channels. The aux IB Tx/Rx 319a, 319b may use the redundant analog crossbars 330a, 330b to communicate with other devices. The aux IB Tx/Rx 319a, 319b may be used to communicate or combine IB traffic, e.g., from one or more of the DSPs IB lanes.

The DSPs 310a, 310b may also have the functionality previously discussed including M×Line Rx 312a, 312b, the M×Line Tx 314a, 314b, the M×ETx to M×M DSP xbar 316a, 316b, and the M×ERx to M×M DSP xbar 318a, 318b. The DSPs 310a, 310b may also have crossbar functionality 340a, 340b. In addition, the DSPs may have OOB Tx/Rx 317a, 317b.

The analog crossbars 320a, 320b may receive IB switch traffic. The analog crossbars 320a, 320b may communicate IB switch traffic from an output.

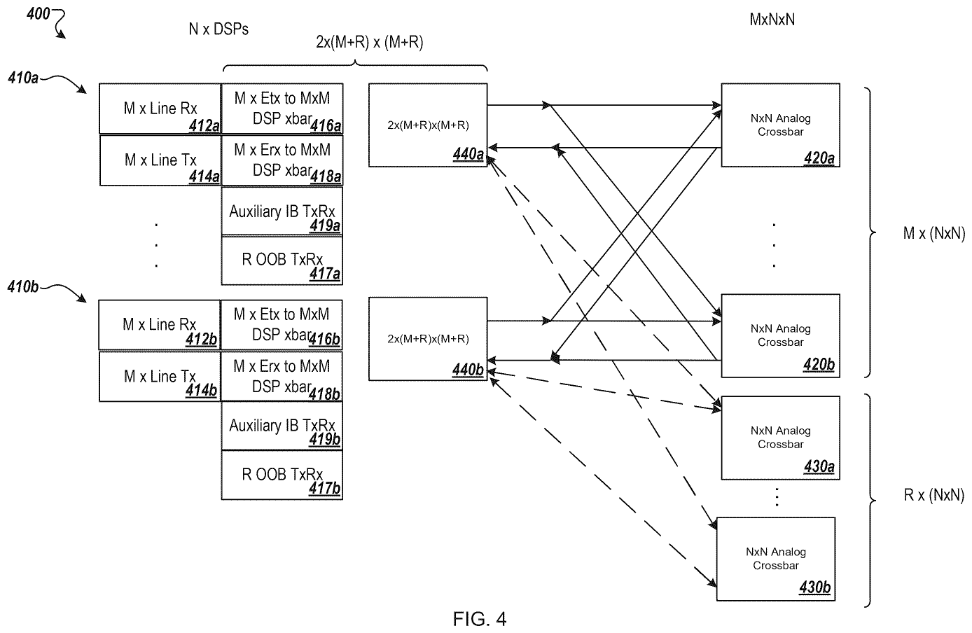

One or more of the DSPs 410a, 410b or the analog crossbars 120a, 120b may include one or more redundant input lanes or one or more redundant output lanes to facilitate failover. As illustrated in FIG. 4, redundancy may be used for make-before-break (MBB) handoff. The aux IB Tx/Rx 419a, 419b may be used for MBB lane switching and may be placed in low power mode during steady state to save power. The DSPs 410a, 410b may also have the functionality previously discussed including M×Line Rx 412a, 412b, the M×Line Tx 414a, 414b, the M×ETx to M×M DSP xbar 416a, 416b, and the M×ERx to M×M DSP xbar 418a, 418b. The DSPs 410a, 410b may also have crossbar functionality 440a, 440b. In addition, the DSPs 410a, 410b may have OOB Tx/Rx 417a, 417b. The DSPs 410a, 410b may direct traffic to (or receive traffic from) one or more of the analog crossbars 420a, 420b or the redundant analog crossbars 430a, 430b.

In one example, one or more redundant lanes may be used for OOB signaling. OOB signaling may be implemented using OOB Tx/Rx within the DSPs or using the switch controller. The switch controller may use one or more of the redundant lanes to connect to the DSPs 410a, 410b. The OOB transceiver may be at a lower rate than the IB Tx/Rx, which may use e.g., inter integrated circuit (I2C), serial peripheral interface (SPI), 10G SERDES, or the like. OOB signaling may be broadcast from a DSP 410a, 410b and/or switch controller to the other DSPs 410a, 410b. Using one or more redundant lanes may implement hitless switching. The switch controller may route in-band traffic through one or more of the redundant lanes.

Out-of-band communication paths may be used to activate the set of redundant crossbars 430a, 430b during failover. For example, OOB communication paths may communicate using OOB Tx/Rx within the DSPs or using the switch controller.

One or more of the redundant lanes may be used for MBB connectivity. For example, one or more of the redundant lanes may be on the switch side of the DSP (e.g., 8 lanes on the line side and e.g., 9 lanes on the switch side to provide a redundant lane). When lane 8 on the switch side fails, then lane 9 may be switched to.

Traffic may be re-routed to the one or more additional input lanes or the one or more additional output lanes when failover occurs without a disruption or latency increase. The DSPs 410a, 410b may include an auxiliary in-band transceiver 419a, 419b for establishing IB connections between DSPs 410a, 410b before handing off to primary transceivers. The auxiliary in-band transceiver 419a, 419b may permit fast reacquisition (lower/zero overhead) switching. The auxiliary in-band transceiver 419a, 419b may allow hitless switching, in which the switch may be reconfigured without interrupting traffic in the lanes, including the affected lanes.

Although FIGS. 1 to 4 have been illustrated with redundant analog crossbars, alternatively or in addition, the DSPs may be redundant. In one example, a device may include DSPs, analog crossbars that may be connected to the DSPs, and a set of redundant DSPs that may be connected to the analog crossbars in which the set of redundant DSPs may provide one or more of additional input lanes or additional output lanes when failover occurs. The set of redundant DSPs may facilitate redundancy for in-band traffic. The set of redundant DSPs may facilitate redundancy for out-of-band traffic.

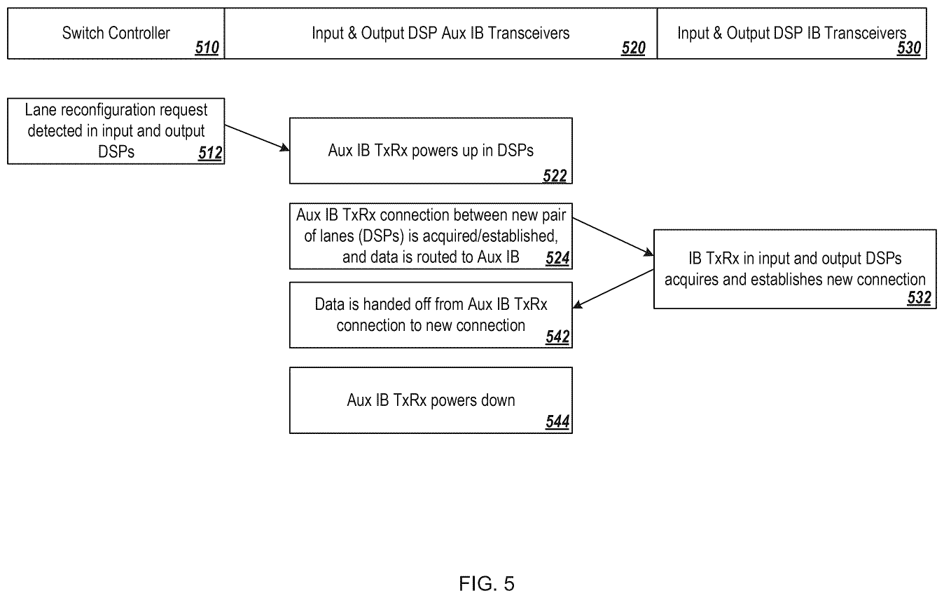

FIG. 5 illustrates an example of MBB handoff. The analog electrical circuit switch (AECS) controller 510 may detect a lane reconfiguration request in input and output DSPs, as shown in block 512. The input and output DSP aux IB transceivers 520 may be powered up in the DSPs, as shown in block 522. The aux IB Tx/Rx connection between new pair of lanes in the DSPs may be acquired and/or established and data may be routed to the auxiliary IB, as shown in block 524. At the input and output DSP IB transceiver 530, the IB Tx/Rx in input and output DSPs may be acquired and may establish a new connection, as shown in block 532. At the input and output DSP aux IB transceivers 520, data may be handed off from the aux IB Tx/Rx connection to a new connection, as shown in block 542. At block 544, the aux IB Tx/Rx may power down.

In addition or alternatively, the aux IB channel may be used to communicate with nearest neighbors. For example, a separate wire may be used to connect to nearest neighbor aux IB lanes. The nearest neighbors may have clean channels between them which may allow for simplified PHY processing for significant power and latency reduction, less equalization, and the like.

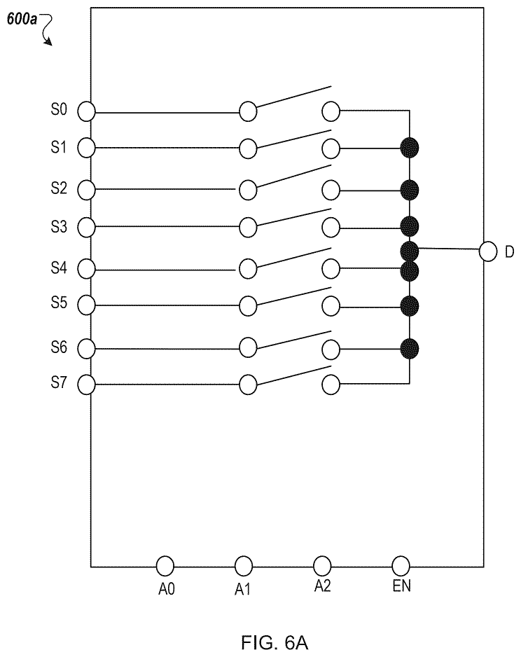

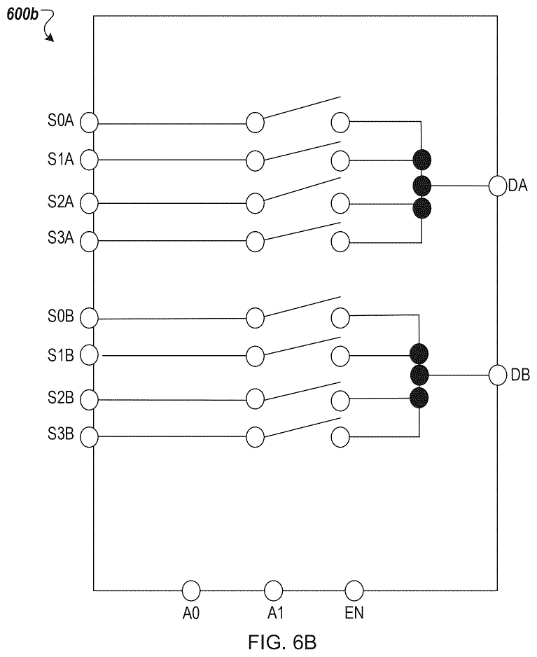

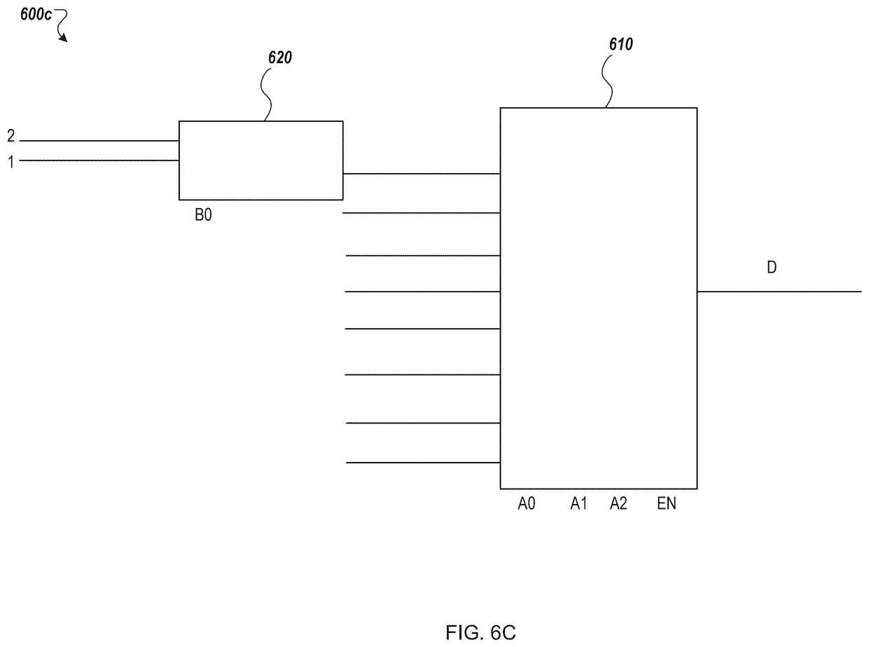

As illustrated in FIG. 6A, an analog switch 600a may be used in different configurations. For example, the external pins (e.g., A0, A1, A2, or the like) may be used to decide the 1:8 selection. For example, when external pin A0 is enabled, external pin A1 is not enabled, and external pin A3 is not enabled, then switch S0 may be enabled. Similarly, other combinations of external pins may be used to enable switches S1 to S7 to provide a 1:8 selection.

As illustrated in FIG. 6B, an analog switch 600b may be two different 4:1 decoders. For decoder A, switches S0A, S1A, S2A, or S3A may be selected by using external pins A0 and/or A1. For decoder B, switches S0B, S1B, S2B, or S3B may be selected by using external pins A0 and/or A1. Thus, external pins may be used to decide a 1:4 selection.

As illustrated in the system 600c in FIG. 6, the analog switch 610 may be modified to allow for redundancy. The first stage may use 1:1 and the second stage may have another 1:2 for each of the 8 lanes. Path 1 on the second switch 620 may be a default but in the event of a failover may switch to path 2. As a result, redundancy is provided for path 1.

Because the energy and latency penalties for an analog electrical circuit switch may be low relative to energy and latency penalties imposed by digital switches, a layer of redundancy switching (i.e., a redundancy crossbar) may be implemented between systems on chip (SOCs) and co-packaged optics (CPO) or front-panel modules. When a module fails (such as during link flap), the redundancy switching may quickly reconnect the affected port of the SOC to a redundant link. For an SOC with N ports, and the switch as R redundant ports, a crossbar may switch any of the N ports to any of the R redundant ports.

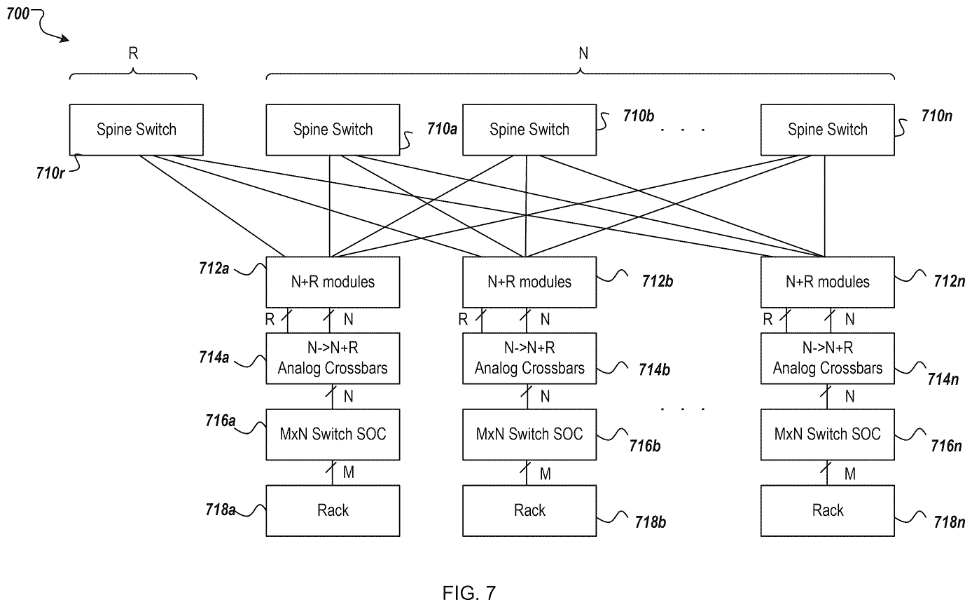

Such a switch is illustrated in FIG. 7, where R may be small and N may be large in order to amortize the cost of redundancy over large numbers of ports due to the low probability of link failure. The redundancy crossbar may include analog equalization and amplification. The redundancy crossbar may be configured and controlled by local or remote controllers but local may be used in order to reduce latency between detection of a failure and fail-over to a redundant port.

As illustrated in FIG. 7, redundant ports may be connected in a network 700 in a spine and leaf configuration. N Spine switches 710a, 710b, 710n may be coupled to N N+R modules 712a, 712b, 712n. That is, spine switch 710a may be coupled to N+R modules 712a, 712b, 712n, spine switch 710b may be coupled to N+R modules 712a, 712b, 712n, and spine switch 710n may be coupled to N+R modules 712a, 712b, 712n.

The N N+R modules 712a, 712b, 712n may be coupled to N to R redundancy crossbars 714a, 714b, 714n using R +N connections. That is, N+R module 712a may be coupled to N to R redundancy crossbar 714a using R+N connections, N+R module 712b may be coupled to N to R redundancy crossbar 714b using N+R connections, and N+R module 712n may be coupled to N to R redundancy crossbar 714n using N+R connections. The N N+R modules 712a, 712b, 712n may be e.g., quad small form-factor pluggable double density (QSFP-DD) or CPO.

The N to R redundancy crossbars 714a, 714b, 714n may be coupled to N M×N switch SOCs 716a, 716b, 716n using N connections. That is, N to R redundancy crossbar 714a may be coupled to M×N switch SOC 716a using N connections, N to R redundancy crossbar 714b may be coupled to M×N switch SOC 716b using N connections, and N to R redundancy crossbar 714n may be coupled to M×N switch SOC 716n using N connections.

The M×N switch SOCs 716a, 716b, 716n may be coupled to racks 718a, 718b, 718n using M connections. That is, M×N switch SOC 716a may be coupled to rack 718a using M connections, M×N switch SOC 716b may be coupled to rack 718b using M connections, and M×N switch SOC 716n may be coupled to rack 718n using M connections.

Redundancy spine switch 710r may be coupled to N+R modules 712a, 712b, 712n. For example, when the number of redundancy spine switches is equal to 1, redundancy spine switch 710r may be coupled to N+R module 712a, 712b, 712n. For additional redundancy spine switches, additional connections may be added to the N+R modules 712a, 712b, 712n.

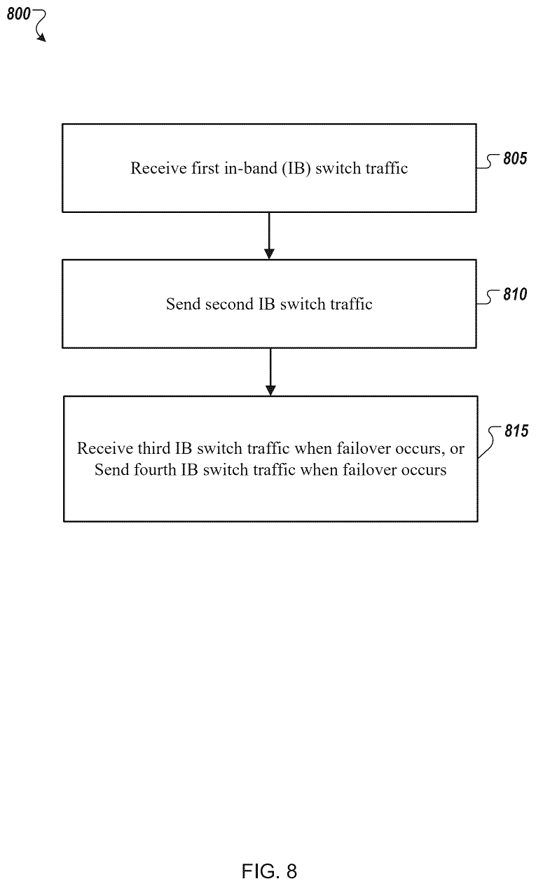

FIG. 8 illustrates a process flow of an example method 800 of redundancy, in accordance with at least one example described in the present disclosure. The method 800 may be arranged in accordance with at least one example described in the present disclosure.

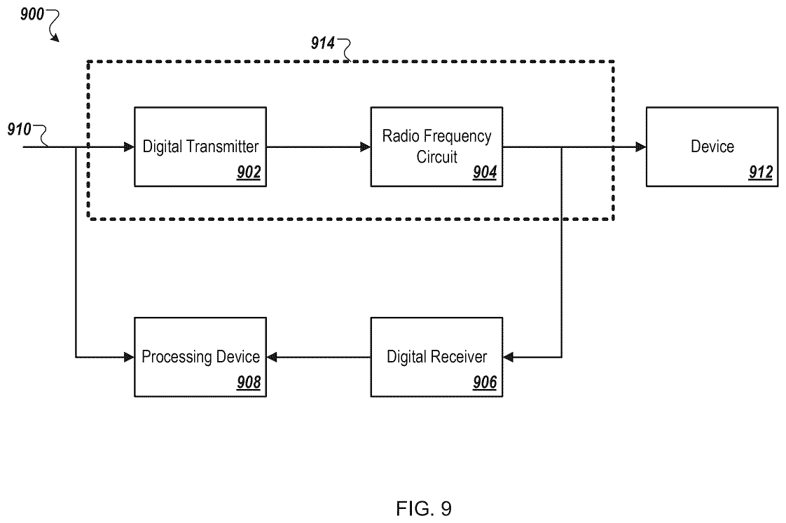

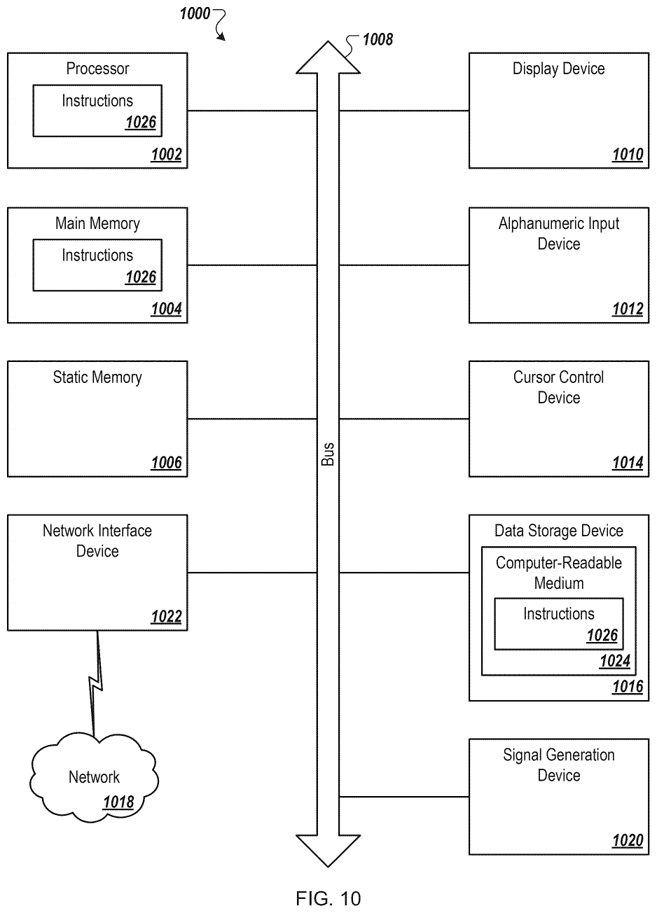

The method 800 may be performed by processing logic that may include hardware (circuitry, dedicated logic, etc.), software (such as is run on a computer system or a dedicated machine), or a combination of both, which processing logic may be included in the processing device 1002 of FIG. 10, the communication system 900 of FIG. 9, or another device, combination of devices, or systems.

The method 800 may begin at block 805 where the processing logic may receive, at a plurality of analog crossbars from a plurality of digital signal processors (DSPs), first in-band (IB) switch traffic.

At block 810, the processing logic may send, from the plurality of analog crossbars to a plurality of DSPs, second IB switch traffic.

At block 815, the processing logic may receive, at a set of redundant analog crossbars from the plurality of DSPs, third IB switch traffic when failover occurs, or send, from the set of redundant analog crossbars to the plurality of DSPs, fourth IB switch traffic when failover occurs.

The processing logic may further receive, at a set of redundant analog crossbars from the plurality of DSPs, out-of-band (OOB) traffic. The processing logic may further send, from the set of redundant analog crossbars to the plurality of DSPs, OOB traffic. The processing logic may further perform, at the set of redundant analog crossbars, make-before-break (MBB) lane switching. The processing logic may further switch, at the plurality of DSPs, from an existing lane to a redundant lane when failover occurs.

Modifications, additions, or omissions may be made to the method 800 without departing from the scope of the present disclosure. For example, in some examples, the method 800 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 9 illustrates a block diagram of an example communication system 900, in accordance with at least one example described in the present disclosure. The communication system 900 may include a digital transmitter 902, a radio frequency circuit 904, a device 912, a digital receiver 906, and a processing device 908. The digital transmitter 902 and the processing device may be configured to receive a baseband signal via connection 910. A transceiver 914 may comprise the digital transmitter 902 and the radio frequency circuit 904.

In some examples, the communication system 900 may include a system of devices that may be configured to communicate with one another via a wired or wireline connection. For example, a wired connection in the communication system 900 may include one or more Ethernet cables, one or more fiber-optic cables, and/or other similar wired communication mediums. Alternatively, or additionally, the communication system 900 may include a system of devices that may be configured to communicate via one or more wireless connections. For example, the communication system 900 may include one or more devices configured to transmit and/or receive radio waves, microwaves, ultrasonic waves, optical waves, electromagnetic induction, and/or similar wireless communications. Alternatively, or additionally, the communication system 900 may include combinations of wireless and/or wired connections. In these and other examples, the communication system 900 may include one or more devices that may be configured to obtain a baseband signal, perform one or more operations to the baseband signal to generate a modified baseband signal, and transmit the modified baseband signal, such as to one or more loads.

In some examples, the communication system 900 may include one or more communication channels that may communicatively couple systems and/or devices included in the communication system 900. For example, the transceiver 914 may be communicatively coupled to the device 912.

In some examples, the transceiver 914 may be configured to obtain a baseband signal. For example, as described herein, the transceiver 914 may be configured to generate a baseband signal and/or receive a baseband signal from another device. In some examples, the transceiver 914 may be configured to transmit the baseband signal. For example, upon obtaining the baseband signal, the transceiver 914 may be configured to transmit the baseband signal to a separate device, such as the device 912. Alternatively, or additionally, the transceiver 914 may be configured to modify, condition, and/or transform the baseband signal in advance of transmitting the baseband signal. For example, the transceiver 914 may include a quadrature up-converter and/or a digital to analog converter (DAC) that may be configured to modify the baseband signal. Alternatively, or additionally, the transceiver 914 may include a direct radio frequency (RF) sampling converter that may be configured to modify the baseband signal.

In some examples, the digital transmitter 902 may be configured to obtain a baseband signal via connection 910. In some examples, the digital transmitter 902 may be configured to up-convert the baseband signal. For example, the digital transmitter 902 may include a quadrature up-converter to apply to the baseband signal. In some examples, the digital transmitter 902 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 902.

In some examples, the transceiver 914 may include one or more subcomponents that may be used in preparing the baseband signal and/or transmitting the baseband signal. For example, the transceiver 914 may include an RF front end (e.g., in a wireless environment) which may include a power amplifier (PA), a digital transmitter (e.g., 902), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 904) of the transceiver 914 may be synchronized with the resource controller via the S-plane device, which may contribute to high-accuracy timing with respect to a reference clock.

In some examples, the transceiver 914 may be configured to obtain the baseband signal for transmission. For example, the transceiver 914 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 914 may be configured to generate a baseband signal for transmission. In these and other examples, the transceiver 914 may be configured to transmit the baseband signal to another device, such as the device 912.

In some examples, the device 912 may be configured to receive a transmission from the transceiver 914. For example, the transceiver 914 may be configured to transmit a baseband signal to the device 912.

In some examples, the radio frequency circuit 904 may be configured to transmit the digital signal received from the digital transmitter 902. In some examples, the radio frequency circuit 904 may be configured to transmit the digital signal to the device 912 and/or the digital receiver 906. In some examples, the digital receiver 906 may be configured to receive a digital signal from the RF circuit and/or send a digital signal to the processing device 908.

In some examples, the processing device 908 may be a standalone device or system, as illustrated. Alternatively, or additionally, the processing device 908 may be a component of another device and/or system. For example, in some examples, the processing device 908 may be included in the transceiver 914. In instances in which the processing device 908 is a standalone device or system, the processing device 908 may be configured to communicate with additional devices and/or systems remote from the processing device 908, such as the transceiver 914 and/or the device 912. For example, the processing device 908 may be configured to send and/or receive transmissions from the transceiver 914 and/or the device 912. In some examples, the processing device 908 may be combined with other elements of the communication system 900.

FIG. 10 illustrates a diagrammatic representation of a machine in the example form of a computing device 1000 within which a set of instructions, for causing the machine to perform any one or more of the methods discussed herein, may be executed. The computing device 1000 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1000 includes a processing device (e.g., a processor) 1002, a main memory 1004 (e.g., read-only memory (ROM), flash memory, dynamic random access memory (DRAM) such as synchronous DRAM (SDRAM)), a static memory 1006 (e.g., flash memory, static random access memory (SRAM)) and a data storage device 1016, which communicate with each other via a bus 1008.

Processing device 1002 represents one or more general-purpose processing devices such as a microprocessor, central processing unit, or the like. More particularly, the processing device 1002 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also include one or more special-purpose processing devices such as an application specific integrated circuit (ASIC), a field programmable gate array (FPGA), a digital signal processor (DSP), network processor, or the like. The processing device 1002 is configured to execute instructions 1026 for performing the operations and steps discussed herein.

The computing device 1000 may further include a network interface device 1022 which may communicate with a network 1018. The computing device 1000 also may include a display device 1010 (e.g., a liquid crystal display (LCD) or a cathode ray tube (CRT)), an alphanumeric input device 1012 (e.g., a keyboard), a cursor control device 1014 (e.g., a mouse) and a signal generation device 1020 (e.g., a speaker). In at least one example, the display device 1010, the alphanumeric input device 1012, and the cursor control device 1014 may be combined into a single component or device (e.g., an LCD touch screen).

The data storage device 1016 may include a computer-readable storage medium 1024 on which is stored one or more sets of instructions 1026 embodying any one or more of the methods or functions described herein. The instructions 1026 may also reside, completely or at least partially, within the main memory 1004 and/or within the processing device 1002 during execution thereof by the computing device 1000, the main memory 1004 and the processing device 1002 also constituting computer-readable media. The instructions may further be transmitted or received over a network 1018 via the network interface device 1022.

While the computer-readable storage medium 1024 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

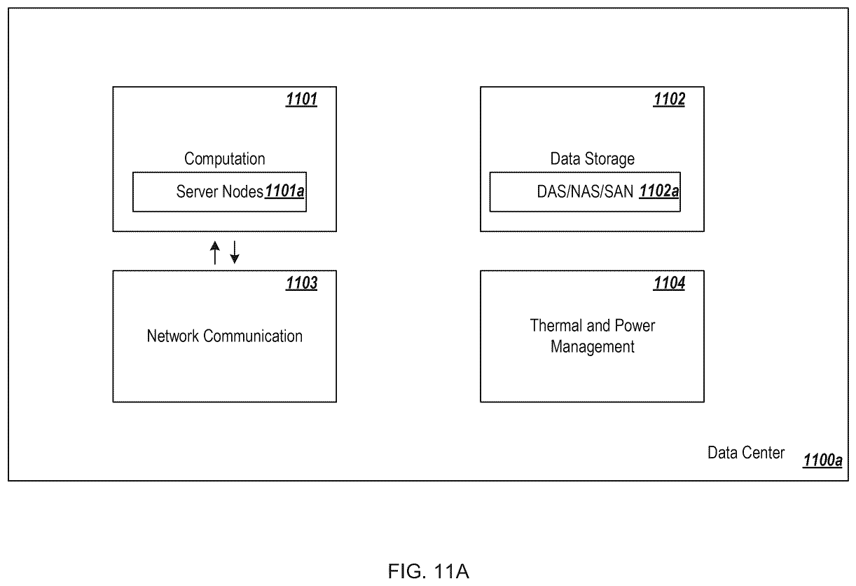

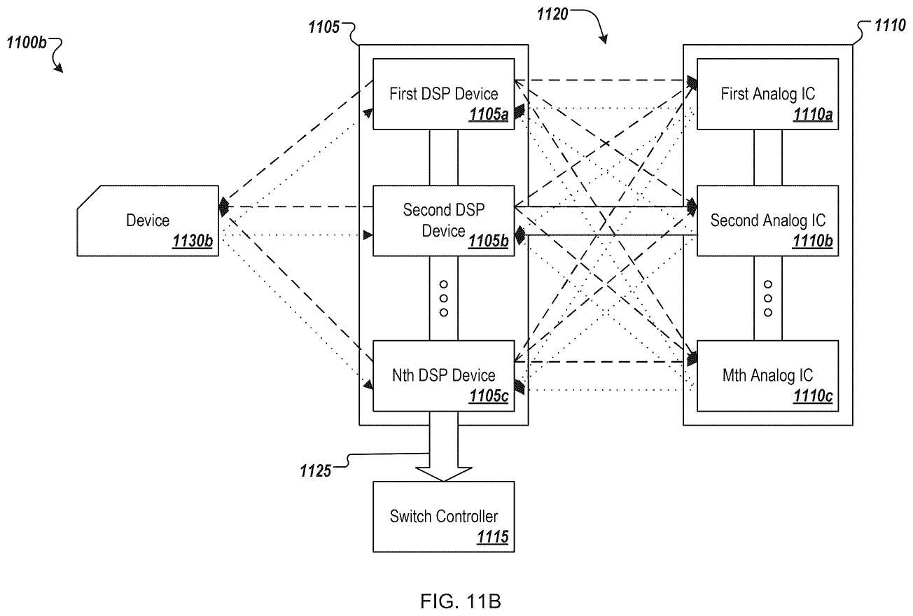

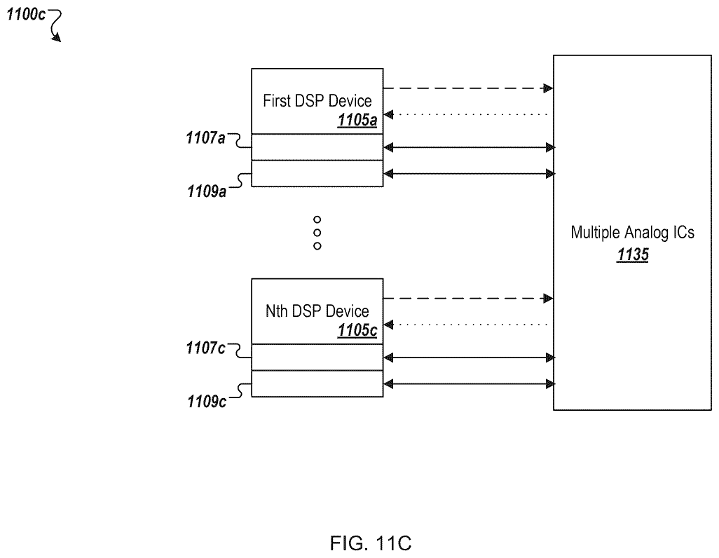

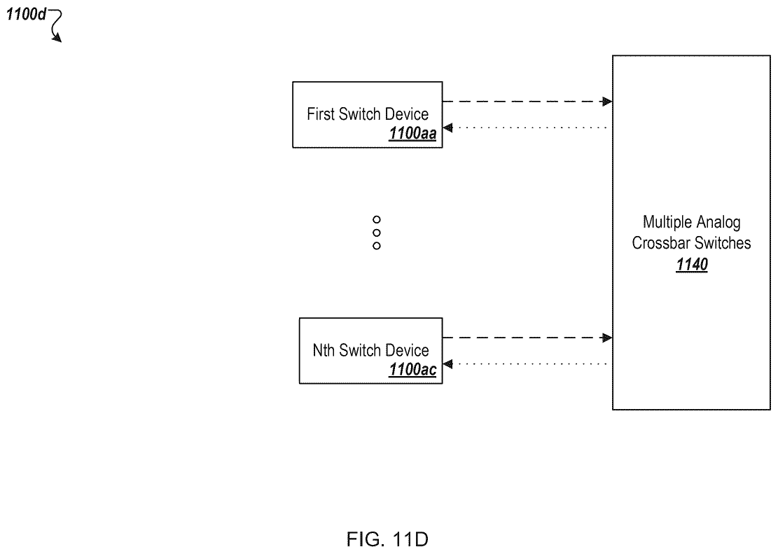

As illustrated in FIG. 11, a block diagram of a data center 1100a may include multiple subsystems configured to perform various operational functions, including computation 1101, data storage 1102, network communication 1103, and thermal and power management 1104. The computation 1101 subsystem may include one or more server nodes 1101a that may execute software applications and process data workloads. The data storage 1102 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 1102a. The networking communication 1103 subsystem may facilitate bidirectional data transfer between servers and external networks through high-speed switching and routing components. The thermal and power management 1104 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 1100a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver all of its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch SOCs with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, ⅕ of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 11B illustrates an example switch device 1100b. The switch device 1100b may include a first digital signal processor (DSP) device 1105a, a second DSP device 1105b, an nth DSP device 1105c, referred to collectively as multiple first electronic devices 1105, a first analog integrated circuit (IC) 1110a, a second analog IC 1110b, an mth analog IC 1110c, referred to collectively as multiple second electronic devices 1110, a switch controller 1115, in-band traffic 1120, and out-of-band traffic 1125. First DSP 1105a, second DSP 1105b, and nth DSP 1105c may have input and output.

The switch device 1100b may be reconfigurable (e.g., in terms of the connections between the components therein, such as the multiple first electronic devices 1105 and the multiple second electronic devices 1110, the switch controller 1115, and/or a device 1130), where the switching of the connections/lanes between the components may be low latency (e.g., less than 5 ns, 10ns, or the like switching). Alternatively, or additionally, the switch device 1100b may reconfigure without the use of retiming such that each lane of the multiple lanes included therein may use less than 50 mW of power. For example, each lane of the multiple lanes may support 100 G bandwidth while using less than 50 mW of power.

The multiple first electronic devices 1105 may individually include one or more ports that may be used to facilitate communications within the switch device 1100b, such as between the multiple first electronic devices 1105 and the multiple second electronic devices 1110, the switch controller 1115, and/or a device 1130. The communications in the switch device 1100b may be transmitted via multiple lanes in the switch device 1100b. The multiple lanes may facilitate the in-band traffic 1120 and/or the out-of-band traffic 1125.

The multiple lanes between the multiple first electronic devices 1105 and the multiple second electronic devices 1110 may be in an any-to-any configuration. For example, the first DSP device 1105a may include a lane to the first analog IC 1110a, to the second analog IC 1110b, and/or the mth analog IC 1110c. A similar arrangement may occur for each of the multiple first electronic devices 1105, such that each DSP device of the multiple first electronic devices 1105 may include a lane to any number of the multiple second electronic devices 1110, including none of the multiple second electronic devices 1110. As illustrated in FIG. 11, each lane for facilitating the in-band traffic 1120 may be in both directions (e.g., transmit and receive) between the multiple first electronic devices 1105, the multiple second electronic devices 1110, and/or a device 1130. Alternatively, or additionally, the lanes are dashed/dotted to illustrate that for any transmit/receive path between the multiple first electronic devices 1105, the multiple second electronic devices 1110, and/or a device 1130, a lane may or may not be present.

The multiple first electronic devices 1105, the multiple second electronic devices 1110, and/or the switch controller 1115 may be disposed on a printed circuit board (PCB) where traces on the PCB may be used to connect at least the multiple first electronic devices 1105, the multiple second electronic devices 1110, and/or the switch controller 1115 (e.g., the traces on the PCB may facilitate the in-band traffic 1120 and/or the out-of-band traffic 1125 in the switch device 1100b). Alternatively, or additionally, the multiple first electronic devices 1105, the multiple second electronic devices 1110, and/or the switch controller 1115 may be connected to one another using connectors, such as high-speed cables, where the multiple first electronic devices 1105, the multiple second electronic devices 1110, and/or the switch controller 1115 may individually include ports/headers to support the use of the connectors. In instances in which the connectors are used, crosstalk between the multiple lanes in the switch device 1100b may be reduced relative to the crosstalk that may occur when the switch device 1100b uses traces on a PCB.

The switch device 1100b, including the multiple first electronic devices 1105, the multiple second electronic devices 1110, and/or the switch controller 1115, may be utilized with one or more additional switches and/or crossbar devices to form a new crossbar switch device, which may be larger than any one of the switch devices 1100b. For example, as illustrated and discussed relative to FIG. 11C, the switch device 1100b may be utilized with any other number of switch devices 1100b (e.g., the nth switch device 1100ac in FIG. 11C) and multiple analog crossbar switches 1140 to form a new crossbar switch device.

The multiple first electronic devices 1105 may be digital signal processors (DSPs) and/or the multiple second electronic devices 1110 may be analog circuit switch integrated circuits (ICs) for use with electrical signals. Alternatively, or additionally the multiple second electronic devices 1110 may be analog optical circuit switch ICs for use with optical signals. The multiple first electronic devices 1105 may be individually configured to support one or more layer of the open systems interconnection (OSI) model. For example, each of the multiple first electronic devices 1105 may be configured to support layer 1 protocols, layer 2 protocols, and/or layer 3 protocols with respect to the in-band traffic 1120 and/or the out-of-band traffic 1125.

Each, or at least one, of the multiple first electronic devices 1105 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 1105 may be able to adjust the way in which traffic is directed through it, such as in response to a command from the switch controller 1115. For example, each of the multiple first electronic devices 1105 may be operable to configure an internal switch, an external switch, or a crossbar based on the various layer protocol processing to be performed.

The first DSP device 1105a may receive a communication that includes a frame header (or a packet header) and the first DSP device 1105a may be configured to detect the frame header and decode the frame header along with any associated contents of the communication, all within the first DSP device 1105a. In a second example, the first DSP device 1105a may integrate a media access control (MAC) address lookup table which may allow the first DSP device 1105a to configure one or more crossbars such that the first DSP device 1105a may facilitate connectivity between any two MAC addresses that are included in the lookup table. Alternatively, or additionally, each of the first electronic devices 1105 may include a lookup table that may store equalization settings that may be used for various connections between the first electronic devices 1105 and other components within the switch device 1100b. The equalization settings in the lookup table may be used to accelerate acquisition and/or tracking for a particular DSP device of the multiple first electronic devices 1105 when the particular DSP device switches connections within the switch device 1100b.

The multiple first electronic devices 1105 may be configured to respond to layer 2 protocol requests and/or layer 3 protocol requests for connectivity and/or resource grant requests. For example, the multiple first electronic devices 1105 may compare a request to a lookup table that includes priority levels and the multiple first electronic devices 1105 may be operable to configure themselves and/or associated crossbars and/or switches based on the determined priority level. Alternatively, or additionally, each of the multiple first electronic devices 1105 may be configured to respond to in-band requests (e.g., granting a connection request, signaling backpressure to the device 1130, etc.), collect statistics on traffic handled by the multiple first electronic devices 1105 (e.g., link utilization and/or traffic type), and/or perform data filtering (e.g., detecting a particular header, performing routing, generating flags and/or interrupts, and/or logging any of the filtering events).

The multiple first electronic devices 1105 may be configured to communicate with (e.g., transmit data to and/or receive data from) the device 1130. The communication with the device 1130 may include in-band traffic 1120. In such instances, the communications between the multiple first electronic devices 1105 and the device 1130 may be line-side communications, where the lines may facilitate communications using various communication channels. For example, the line-side communications between the multiple first electronic devices 1105 and the device 1130 may be an electrical-to-electrical connection, an optical-to-optical connection, an electrical-to-optical connection, or an optical-to-electrical connection, and so forth.

The device 1130 may address communications directly to one of the multiple first electronic devices 1105. For example, the device 1130 may address communications to the second DSP device 1105b. Alternatively, or additionally, the device 1130 may address communications to the switch controller 1115, which may then direct communications to the appropriate DSP device. For example, the device 1130 may address communications intended for the second DSP device 1105b to the switch controller 1115 and the switch controller 1115 may direct the communications to the second DSP device 1105b.

The multiple first electronic devices 1105 may individually include memory that may be used as a buffer for communications through the multiple first electronic devices 1105. The memory in the multiple first electronic devices 1105 may be utilized to buffer incoming and/or outgoing traffic, which may include in-band traffic 1120 and/or out-of-band traffic 1125. Due to the memory in the multiple first electronic devices 1105 being distributed (e.g., by the distributed nature of the multiple first electronic devices 1105), the switch device 1100b may not include any memory for buffering in addition to the memory included in the multiple first electronic devices 1105.

The multiple first electronic devices 1105 may individually include one or more additional lanes that may be used for communications in the switch device 1100b. Further details associated with the additional lanes are included in the description associated with FIG. 11C.

The multiple second electronic devices 1110 may individually include one or more ports that may be used to facilitate communications within the switch device 1100b, similar to the ports described relative to the multiple first electronic devices 1105. Alternatively, or additionally, the lanes for communications between the multiple first electronic devices 1105 and the multiple second electronic devices 1110 may be coupled with the ports included in the multiple second electronic devices 1110.

The switch controller 1115 may be a microcontroller unit (MCU). Alternatively, or additionally, the switch controller 1115 may be a DSP, or other processing device. The switch controller 1115 may be communicatively coupled with at least the multiple first electronic devices 1105 and/or the multiple second electronic devices 1110. The switch controller 1115 may resolve resource grant requests, distribute the network state to the multiple first electronic devices 1105 and/or to the multiple second electronic device 1110, and/or may establish and/or maintain timing among the components included in the switch device 1100b.

The switch controller 1115 may communicate with the multiple first electronic devices 1105 and/or the multiple second electronic devices 1110 using a separate connection/lane than the connections between the multiple first electronic devices 1105 and the multiple second electronic devices 1110. For example, the first connection between the multiple first electronic devices 1105 and the multiple second electronic devices 1110 may facilitate the in-band traffic 1120 and the second connection between the switch controller 1115 and the multiple first electronic devices 1105 and/or the multiple second electronic devices 1110 may facilitate the out-of-band traffic 1125.

The out-of-band traffic 1125 may use a different network than the in-band traffic 1120. Alternatively, or additionally, the out-of-band traffic 1125 may use a different physical layer protocol than the in-band traffic 1120. The out-of-band traffic 1125 may be used to manage and/or configure one or more components included in the switch device 1100b. For example, the switch controller 1115 may communicate with the multiple first electronic devices 1105 using the out-of-band traffic 1125 to reconfigure lanes and/or traffic routing based on the traffic through the switch device 1100b.

The switch controller 1115 may be programmable such that the switch controller 1115 may be operable to dynamically map the lanes between the multiple first electronic devices 1105 and the multiple second electronic devices 1110. For example, in instances in which the first DSP device 1105a includes a lane to the first analog IC 1110a, the switch controller 1115 may dynamically map the lane to be from the first DSP device 1105a to the second analog IC 1110b. The switch controller 1115 may dynamically adapt the mapping of the lanes between the multiple first electronic devices 1105 and the multiple second electronic devices 1110 based on one or more conditions and/or a satisfaction of a threshold related to the conditions. For example, in instances in which the real-time data traffic in the switch device 1100b (or an amount of real-time data traffic handled by one of the multiple first electronic devices 1105 and/or one of the multiple second electronic devices 1110) satisfies a threshold, the switch controller 1115 may dynamically adapt the mapping of the lanes as described.

The switch device 1100b may include one or more redundant lanes that may be used in various situations during operation of the switch device 1100b. For example, one or more redundant lanes may be used for the out-of-band traffic 1125, such as signaling using the out-of-band traffic 1125. In such instances, the out-of-band signaling may be transmitted and/or received by a particular DSP device and/or by the switch controller 1115, and the out-of-band signaling may be a lower transmission rate than the in-band traffic 1120. In another example, one or more redundant lanes may be used for out-of-bandwidth broadcasts from the switch controller 1115 and/or from one or more of the multiple first electronic devices 1105 to other devices in the switch device 1100b (e.g., such as other DSP devices).

The switch controller 1115 may reserve a portion of bandwidth associated with the in-band traffic 1120 in the switch device 1100b. The bandwidth reserved by the switch controller 1115 may be reserved on a per lane basis of the multiple lanes included in the switch device 1100b. For example, a first lane between the first DSP device 1105a and the first analog IC 1110a may have a first reserved bandwidth and a second lane between the second DSP device 1105b and the second analog IC 1110b may have a second reserved bandwidth, where the amount of bandwidth reserved may be the same or may differ between the first reserved bandwidth and the second reserved bandwidth. The switch controller 1115 may allocate resources within the switch device 1100b based on predicted or anticipated traffic (e.g., based on a probabilistic model).

Alternatively, or additionally, the switch controller 1115 may monitor the lanes of the multiple lanes in the switch device 1100b. The switch controller 1115 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 1115 may dynamically remap a new lane in the switch device 1100b to replace the degraded lane.

The switch controller 1115 may perform adaptive signal equalization to the in-band traffic 1120 in the switch device 1100b. For example, the multiple first electronic devices 1105 may provide feedback to the switch controller 1115 relative to the workload handled by the multiple first electronic devices 1105, and the switch controller 1115 may adaptively manage workloads of the multiple first electronic devices 1105 to optimize performance of the switch device 1100b.

A backup switch controller (not illustrated) may be included in the switch device 1100b. The backup switch controller may be a redundant controller relative to the switch controller 1115. The backup switch controller may include the same or similar connections as the switch controller 1115 relative to the multiple first electronic devices 1105 and/or the multiple second electronic devices 1110. The backup switch controller may perform the same or similar operations as the switch controller 1115.

FIG. 11C illustrates an example switch device 1100c. The switch device 1100c may include a first DSP device 1105a, an nth DSP device 1105c, and multiple analog ICs 1135. The first DSP device 1105a may include a first auxiliary channel 1107a, and a first out-of-band channel 1109a. The nth DSP device 1105c may include an nth auxiliary channel 1107c, and an nth out-of-band channel 1109c.

The first DSP device 1105a, the nth DSP device 1105c, and the multiple analog ICs 1135 may be the same or similar as the first DSP device 1105a, the nth DSP device 1105c, and the multiple second electronic devices 1110, respectively, of FIG. 11A and may be operable to perform the same or similar functions as described.

The auxiliary channels 1107 (e.g., the first auxiliary channel 1107a and the second auxiliary channel 1107c) may be individually utilized by each of the DSP devices 1105a, 1105c as an additional lane for in-band traffic between at least the DSP devices 1105a, 1105c and the multiple analog ICs 1135. The auxiliary channels 1107 may be used to redundantly transmit in-band traffic relative to another lane included in the DSP devices 1105a, 1105c prior to a change in configuration to the corresponding DSP devices 1105a, 1105c. For example, in instances in which the first DSP device 1105a includes a lane to a particular analog IC of the multiple analog ICs 1135 and the first DSP device 1105a is to be reconfigured (e.g., by a switch controller as described herein), the first auxiliary channel 1107a may have a lane mapped to the particular analog IC such that the in-band traffic is redundant between the first DSP device 1105a and the particular analog IC prior to reconfiguring the lanes associated with the first DSP device 1105a (which reconfiguration may otherwise break the connection between the first DSP device 1105a and the particular analog IC).

The auxiliary channels 1107 may be used for communication between other near DSP devices. For example, in instances in which the first DSP device 1105a is disposed spatially near to the nth DSP device 1105c, the first DSP device 1105a and the nth DSP device 1105c may communicate with one another via the auxiliary channels 1107. Such communications may be possible as the channels between near-neighbors may be relatively clean, such that physical layer processing may be simplified and may result in power reduction, latency reduction, a lesser amount of equalization, and/or other benefits to the switch device 1100c.

The out-of-band channels 1109 may be used to communicate the out-of-band traffic (e.g., the out-of-band traffic 1125 of FIG. 11B) on a lane separate from the multiple lanes used to communicate in-band traffic. In such instances, the out-of-band channels 1109 may not cause blocking or interference to the in-band traffic between at least the DSP devices 1105a, 1105c and the multiple analog ICs 1135.

FIG. 11D illustrates an example aggregated switch device 1100d. The aggregated switch device 1100d may include a first switch device 1100aa, an nth switch device 1100ac, and multiple analog crossbar switches 1140. The first switch device 1100aa and the nth switch device 1100ac may individually be the same or similar as the switch device 1100b of FIG. 11B.

The aggregated switch device 1100d illustrates that any number of the switch devices 1100b (e.g., the first switch device 1100aa and the nth switch device 1100ac) may be aggregated into another switch device and/or connected to other analog crossbar switches. Each of the switch devices 1100b may include multiple DSP devices and multiple analog IC and may be further aggregated into the aggregated switch device 1100d using the multiple analog crossbar switches 1140. As such, the aggregated switch device 1100d may be scaled up or down for any size communication need, by adjusting the switch devices 1100b and/or the multiple analog crossbar switches 1140 to meet the communication demand.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,“ “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a plurality of digital signal processors (DSPs);
a plurality of analog crossbars operable to be connected to the plurality of DSPs; and
a set of redundant analog crossbars operable to be connected to the plurality of DSPs, wherein the set of redundant analog crossbars are operable to provide one or more of additional input lanes or additional output lanes when failover occurs.

2. The device of claim 1, wherein the set of redundant analog crossbars facilitates redundancy for in-band traffic.

3. The device of claim 1, wherein the set of redundant analog crossbars facilitates redundancy for out-of-band traffic.

4. The device of claim 1, wherein the set of redundant analog crossbars routes out-of-band traffic to the plurality of DSPs without blocking in-band traffic.

5. The device of claim 1, wherein the plurality of DSPs comprises one or more out-of-band transceivers.

6. The device of claim 1, wherein the plurality of DSPs comprises one or more auxiliary in-band transceivers.

7. The device of claim 6, wherein the one or more auxiliary in-band transceivers are used for make-before break (MBB) lane switching.

8. The device of claim 1, wherein one or more of the plurality of DSPs or the plurality of analog crossbars comprises one or more redundant input lanes or one or more redundant output lanes to facilitate failover.

9. The device of claim 1, wherein traffic is re-routed to the one or more additional input lanes or the one or more additional output lanes when failover occurs without a disruption or latency increase.

10. The device of claim 1, wherein out-of-band communication paths are used to activate the set of redundant crossbars during failover.

11. The device of claim 1, further comprising non-volatile memory operable to store and recover a crossbar state after power loss.

12. A method, comprising:
receiving, at a plurality of analog crossbars from a plurality of digital signal processors (DSPs), first in-band (IB) switch traffic;
sending, from the plurality of analog crossbars to a plurality of DSPs, second IB switch traffic; and
receiving, at a set of redundant analog crossbars from the plurality of DSPs, third IB switch traffic when failover occurs, or
sending, from the set of redundant analog crossbars to the plurality of DSPs, fourth IB switch traffic when failover occurs.

13. The method of claim 12, further comprising:
receiving, at a set of redundant analog crossbars from the plurality of DSPs, out-of-band (OOB) traffic.

14. The method of claim 12, further comprising:
sending, from the set of redundant analog crossbars to the plurality of DSPs, out-of-band (OOB) traffic.

15. The method of claim 12, further comprising:
performing, at the set of redundant analog crossbars, make-before-break (MBB) lane switching.

16. The method of claim 12, further comprising:
switching, at the plurality of DSPs, from an existing lane to a redundant lane when failover occurs.

17. A device, comprising:
a plurality of digital signal processors (DSPs);
a plurality of analog crossbars operable to be connected to the plurality of DSPs;
a set of redundant DSPs operable to be connected to the plurality of analog crossbars, wherein the set of redundant DSPs are operable to provide one or more of additional input lanes or additional output lanes when failover occurs.

18. The system of claim 17, wherein the set of redundant DSPs facilitates redundancy for in-band traffic.

19. The system of claim 17, wherein the set of redundant DSPs facilitates redundancy for out-of-band traffic.

20. The system of claim 17, further comprising non-volatile memory operable to store and recover a crossbar state after power loss.
